(19) United States
(12) Patent Application Publication
(10) Pub. No.: US 2011/0030656 A1
(43) Pub. Date: Feb. 10, 2011

(54) Fuel Injector to Fuel Rail Coupling

(76) Inventors: Dean M. Pepperine, Vergennes, VT (US); Kevin R. Keegan, Hilton, NY (US); Chris M. De Minco, Rush, NY (US); Kirk W. Caloroso, Rochester, NY (US); Jared I. Meeker, Rochester, NY (US)

Correspondence Address: Delphi Technologies, Inc., M/C 480-410-202, P.O. Box 5052, Troy, MI, 48007, US

(21) Appl. No.: 12/538,485

(22) Filed: Aug. 10, 2009

(51) Int. Cl. F02M 61/14

(52) U.S. Cl. 123/470

(57) ABSTRACT

A threaded fastener having a conical seat is provided to mechanically couple a fuel injector assembly to a fuel rail assembly. By mating the conical seat with a spherical collar integral with the fuel injector assembly, an injector coupling is provided that mechanically supports loads from relatively high fuel pressure and combustion pressure while allowing the injector assembly to pivot relative to the fuel rail assembly. A biasing member is provided to pre-load the spherical collar against the mating conical seat.

### TECHNICAL FIELD

The present invention relates to fuel injection systems of internal combustion engines; more particularly to fuel rail assemblies for supplying highly pressurized fuel to fuel injectors for direct injection into engine cylinders; and most particularly, to an apparatus and method for coupling a fuel injector for gasoline direct injection to a fuel rail.

### BACKGROUND OF THE INVENTION

Fuel rails for supplying fuel to fuel injectors of internal combustion engines are well known. A fuel rail assembly, also referred to herein simply as a fuel rail, is essentially an elongated tubular fuel manifold connected at an inlet end to a fuel supply system and having a plurality of ports for mating in any of various arrangements with a plurality of fuel injectors to be supplied. Typically, a fuel rail assembly includes a plurality of fuel injector sockets in communication with a manifold supply tube, the injectors being inserted into the sockets at the injectors' fuel inlet ends.

Fuel injection systems may be divided generally into Multi-Port Fuel Injection (MPFI), wherein fuel is injected from the fuel outlet end of the injector into a runner of an air intake manifold ahead of a cylinder intake valve, and Direct Injection (DI), wherein fuel is injected directly into the combustion chamber of an engine cylinder, typically during or at the end of the compression stroke of the piston. DI is designed to allow greater control and precision of the fuel charge to the combustion chamber, resulting in better fuel economy and lower emissions. DI is also designed to allow higher compression ratios, delivering higher performance with lower fuel consumption compared to other fuel injection systems.

A Gasoline DI (GDI) fuel rail assembly must sustain much higher fuel pressures than a gasoline MPFI fuel rail assembly to assure precise metering of injected fuel into a cylinder during the compression stroke. GDI fuel rail assemblies may be pressurized to about 100 atmospheres or more, for example, whereas MPFI fuel rail assemblies may sustain pressures in the magnitude of about 4 atmospheres.

To withstand higher pressures, fuel injectors of GDI fuel systems are typically supported rigidly on the engine's cylinder head and are, therefore, regarded as “non-hanging” injectors. On the other hand, a hanging injector system typically used on MPFI injectors suspends the injectors from the fuel rail via a mechanical coupling at the fuel rail. Since no hard connection exists between the injector and the cylinder head, hanging injectors are preferred for reducing acoustic noise. However, since a hanging injector is not rigidly supported at the cylinder head, if used in a GDI fuel system, it may not be capable of mechanically supporting loads originating from higher fuel pressures and from opposing combustion pressure imposed on the fuel injector.

What is needed in the art is a GDI fuel injector to fuel rail connection of the hanging injector type that is able to withstand the higher fuel and opposing combustion pressures.

It is a principal object of the present invention to provide a hanging fuel injector coupling for a GDI fuel injector that is able to manage relatively high fuel and combustion pressures.

### SUMMARY OF THE INVENTION

Briefly described, a fuel injector coupling includes a coupling member such as a threaded nut to mechanically connect a fuel injector assembly to an injector socket of a fuel rail assembly, such that the fuel injector is in fluid communication with the interior of a fuel conduit. The threaded nut may be contained as part of the fuel injector assembly. Utilizing a threaded nut to connect the fuel injector with a fuel rail provides a simple and reliable fuel injector-to-fuel rail connection that is able to withstand separating loads originating from the pressures of a DI fuel system.

In one aspect of the invention, an outward extending spherical collar is integrated into the upper housing of a fuel injector. The spherical collar mates with a conical seat integrated into an inner circumferential contour of the threaded nut, thereby providing a seal against fuel leakage, even while the injector may be skewed or tilted because of a dimensional mis-alignment between the fuel rail and engine cylinder head.

In another aspect of the invention, a biasing member, positioned between the injector and the injector socket, provides a force that keeps the spherical collar of the fuel injector in sealable contact with the conical seat of the threaded nut against the force of the opposing combustion chamber pressures.

In still another aspect of the invention, a means for rotationally orienting the fuel injector assembly relative to the fuel rail assembly may be integrated into the hanging injector fuel system to properly position the injector tip in the combustion chamber. For example, a tab and receiving notch may be formed in the socket and fuel injector assembly to fix the proper alignment of the fuel injector assembly.

The fuel injector coupling in accordance with the invention adapts a hanging injector system to a GDI fuel system thereby eliminating hard contact between the injector and the cylinder head. The coupling compensates for any dimensional mis-alignment among the components while supporting the opposing high pressures inherent with a GDI system.

### BRIEF DESCRIPTION OF THE DRAWINGS

The present invention will now be described, by way of example, with reference to the accompanying drawings, in which:

FIG. 1 is an isometric view of a hanging injector fuel system including a biasing member, in accordance with the invention;

FIG. 2 is an exploded isometric view of the assembled hanging injector fuel system shown in FIG. 1;

FIG. 3 is a cross-sectional front view of the hanging fuel injector system shown in FIGS. 1 and 2;

FIG. 4 is a cross-sectional side view of the hanging fuel injector system shown in FIGS. 1 and 2; and

FIG. 5 is a cross-sectional view of a hanging fuel injector system including another type of biasing member, in accordance with the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

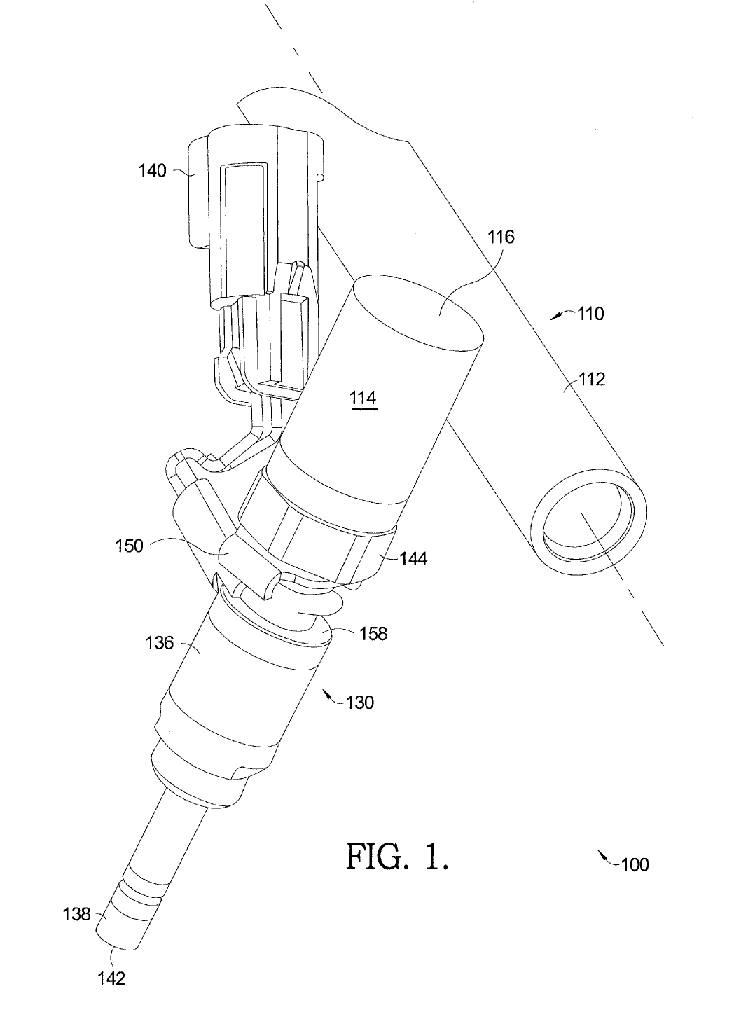

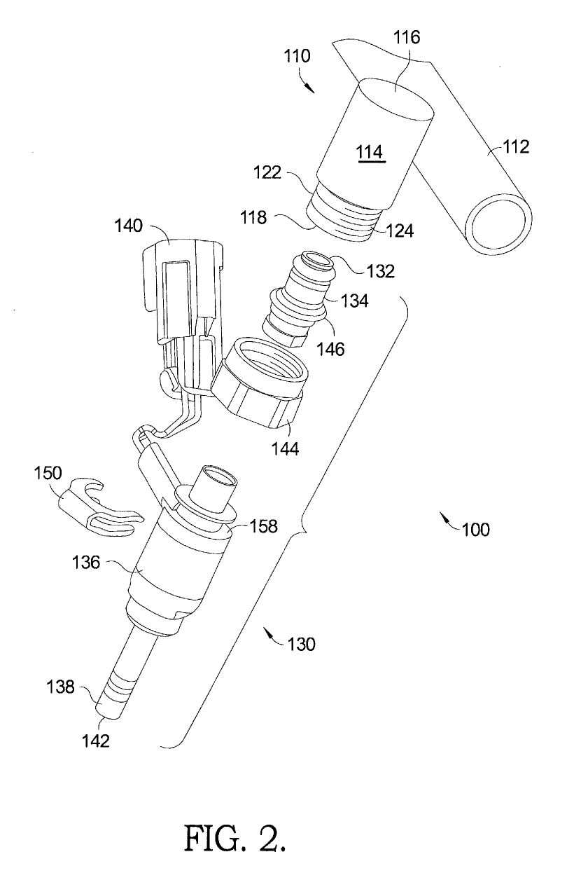

Referring to FIGS. 1 through 4, a first hanging injector fuel system 100 suitable for use in a GDI system includes a fuel rail assembly 110, a fuel injector assembly 130, and a biasing member 150. Fuel rail assembly 110 includes a fuel distribution conduit 112 that may be, for example, an elongated tube as shown in FIGS. 1 and 2. At least one injector socket 114 is adapted to conduit 112 to be in fluid communication with the interior of conduit 112. Fuel rail assembly 110 is preferably connected to a typical fuel supply system (not shown) for receiving fuel from a fuel pump (not shown).

Injector socket 114 may have a generally cylindrical geometric shape, may be closed at a first end 116 and open at an opposite second end 118 for receiving a fuel inlet end 132 of fuel injector assembly 130. Accordingly, injector socket 114 may have, but is not limited to, the shape of a cup. Injector socket 114 includes a threaded area 122 positioned proximate to the open second end 118. A continuous helical thread 124 is formed in an outer circumferential contour of injector socket within area 122, as shown in FIGS. 2, 3, and 4.

As shown in detail in FIG. 2, fuel injector assembly 130 includes an upper housing 134 positioned at fuel inlet end 132, a main body 136 connected to upper housing 134, an injection tip 138 extending from main body 136 towards a fuel outlet 142, and a coupling member for attaching to socket 114 such as, for example, threaded nut 144 positioned proximate upper housing 134. An electrical connector 140 is connected to main body 136 for providing electrical energy to actuate the fuel injector, as known in the art. Main body 136, threaded nut 144, and upper housing 134 are shown as separate parts in FIG. 2 for illustration purpose only.

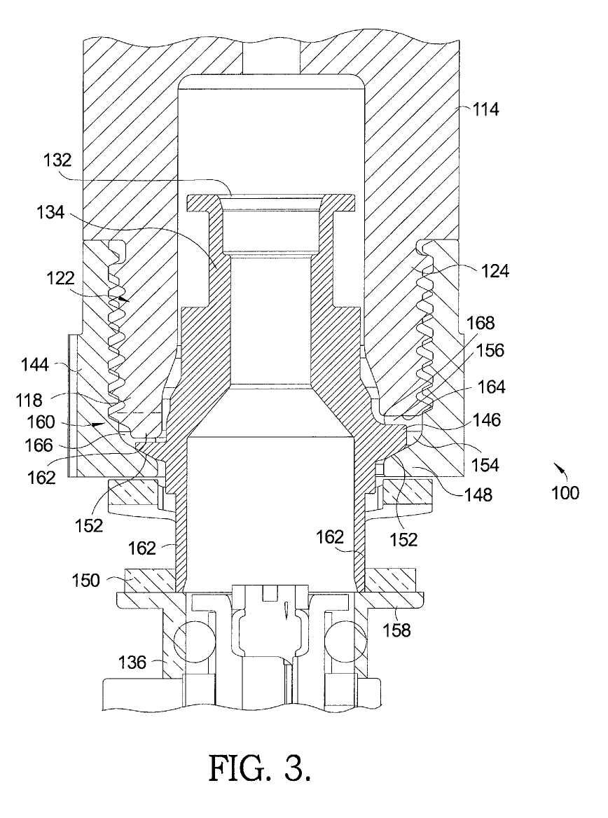

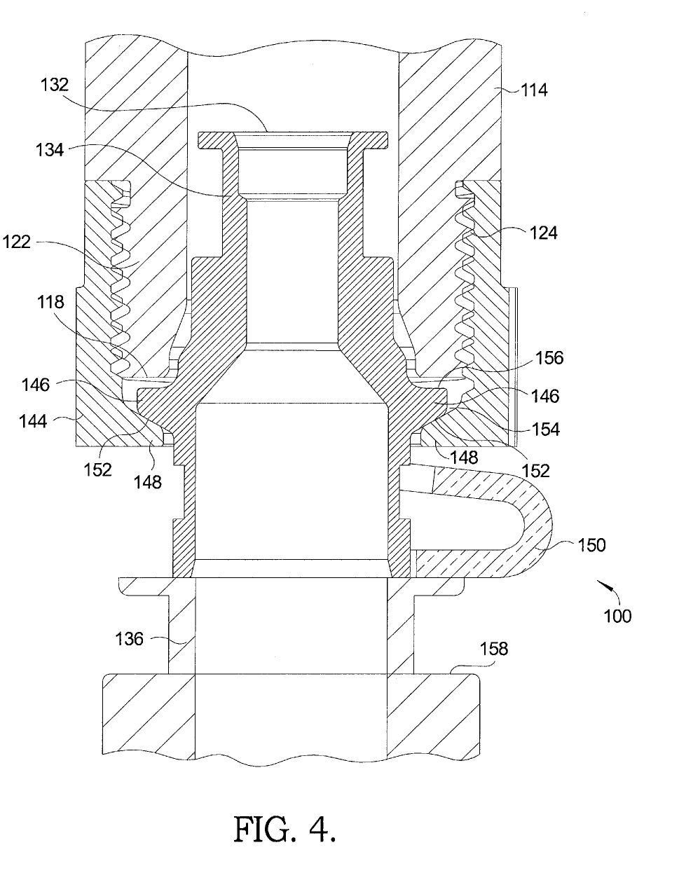

Upper housing 134 includes a spherical collar 146 having an outward extending circular edge, integrated into the outer circumferential contour. Threaded nut 144 has a generally cylindrical geometric shape, is threaded at the inner circumferential contour for engagement with helical thread 124, and includes a conical seat 148 (shown in FIGS. 3 and 4) that is positioned below spherical collar 146 when assembled. Threaded nut 144 is fastened to threaded area 122 of injector socket 114 during is assembly of fuel injector system 100 to mechanically connect fuel injector assembly 130 with fuel rail assembly 110. A lateral clearance area 154 is formed between the outer circumference of spherical collar 146 and the inner circumferential contour of threaded nut 144. Some amount of lateral displacement of the injector assembly 130 relative to injector socket 114 within clearance area 154 is provided to simplify assembly of hanging fuel injector system 100. Spherical collar 146 and conical seat 148 allow injector assembly 130 to move within clearance area 154 between injector socket 114 and threaded nut 144 in order to compensate for dimensional mis-alignment between the fuel rail and cylinder head.

After nut 144 is tightened so that nut face 145 is in contact with surface 126 of socket 114, a vertical clearance area 156 is also formed between second end 116 of injector socket 114 and spherical collar 146 of fuel injector assembly 130. Vertical clearance area 156 is provided to allow some movement of the components to also compensate for dimensional mis-alignment among the components.

Conical seat 148 and spherical collar 146 include mating surfaces 152. Mating surfaces 152 are configured so that sealing against fuel leakage is provided even while injector assembly 130 may be skewed or tilted with respect to fuel rail assembly 110 because of dimensional mis-alignment.

A biasing member 150, such as the spring-clip shown in FIGS. 1-4, may be installed after threaded nut 144 has been attached to injector socket 114. Biasing member 150 may be installed, for example, between a radially extending shoulder 158 integrated into main body 136 and threaded nut 144 (as shown in FIG. 3) to provide a downward force on the injector assembly, in the direction of fuel flow, to oppose combustion forces. Biasing member 150 maintains contact between spherical collar 146 and conical seat 148 at mating surfaces 152 to oppose the upward forces imposed on the injector assembly during a combustion event.

An orientation feature 160 may also be employed to assure proper rotational alignment of fuel injector assembly 130 with its mating socket 114, about the injector assembly's longitudinal axis. Feature 160 includes tab 162 extending below end 164 of injector socket 114 for only a small angular portion of the circumference of end 164. Spherical collar 146 of injector assembly 130 has a notch 166 disposed in a complementary small angular portion of circumferential shoulder 168 of collar 146 to receive tab 162 to fix the rotational alignment of the injector assembly.

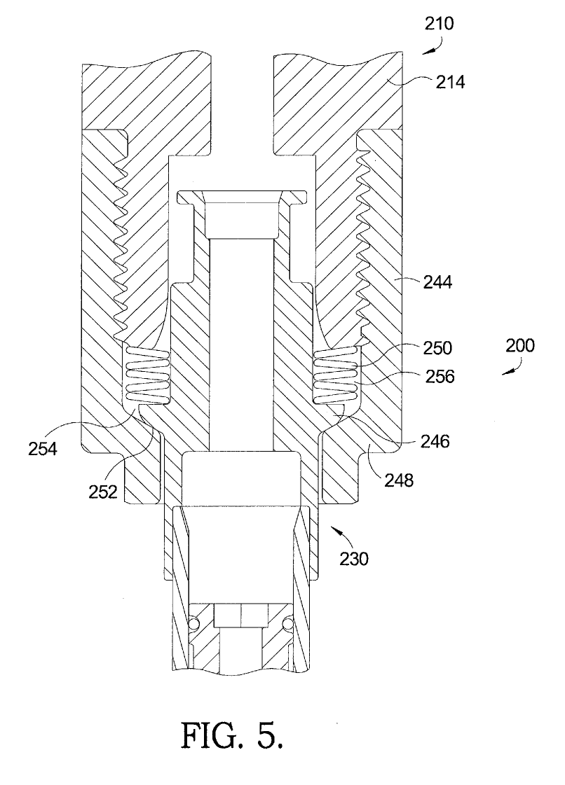

Referring to FIG. 5, a second hanging fuel injector system 200 includes a different type of biasing member 250 than biasing member 150 of the first hanging fuel injector system 100 shown in FIGS. 1 through 4. Features of second hanging fuel injector system 200 shown in FIG. 5 analogous with those of the first hanging fuel injector system 100 shown in FIGS. 1 through 4 carry the same numbers but in the 200 series.

Biasing member 250 may be, for example, a disc spring stack as shown in FIG. 5 or a compression spring. Member 250 is positioned between injector socket 214 and spherical collar 246 within vertical clearance area 256. Member 250 may be positioned in vertical clearance area 256 prior to attaching threaded nut 244 to injector socket 214. After nut 244 is tightened so that nut face 245 is in contact with surface 226 of socket 214, biasing member 250 loads injector 230 downward (in the direction of fuel flow) against conical seat 248. The mating surfaces 252 of spherical collar 246 and conical seat 248 allow injector assembly 120 to move within lateral clearance area 254 and vertical clearance area 256 in order to compensate for any mis-alignment of the injector assembly due to a stack-up of dimensional tolerances among the components. Biasing member 250 maintains contact between spherical collar 246 and conical seat 248 to oppose the forces of combustion during a combustion event.

By providing a threaded nut 144 or 244 having a conical seat 148 or 248 to mechanically couple a fuel injector assembly 130 or 230 to a fuel rail assembly 110 or 120 and by mating the conical seat 148 or 248 with a spherical collar 146 or 246 integral with the fuel injector assembly 130 or 230, respectively, an injector coupling is provided that mechanically supports loads from relatively high fuel pressure and combustion pressure while allowing the injector assembly 130 or 230 to pivot relative to the fuel rail assembly 110 or 210, respectively. By providing a spring preload via biasing members 150, 250, sealing between the injector assembly and socket can be maintained.

While fuel injector systems 100 and 200 are shown as fuel injector systems for direct injection, applications of the features in accordance with the invention in MPFI systems may be possible.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A fuel injector to fuel rail coupling of an internal combustion engine, comprising:
an injector socket in fluid communication with said fuel rail;
a coupling member matingly attachable to said socket adapted to capture said fuel injector and to connect said fuel injector to said fuel rail; and
a biasing member that enables said fuel injector to pivot relative to said injector socket within said coupling member and urges said fuel injector into contact with said coupling member;
wherein said injector socket includes a first threaded section, said coupling member includes a second treaded section adapted to matingly connect with said first threaded section for connecting said fuel injector to said fuel rail.

2. The coupling of claim 1, wherein said coupling member is part of an assembly of said fuel injector.

3. The coupling of claim 1, wherein said biasing member is a spring clip.

4. The coupling of claim 1, wherein said biasing member is a compression spring.

5. The coupling of claim 4 wherein said compression spring comprises at least one disc spring.

6. The coupling of claim 1, further including coincident keyed features configured to provide rotational orientation of said fuel injector relative to said injector socket.

7. The coupling of claim 1, wherein said fuel injector includes a collar and wherein said collar is captured by said coupling member.

8. The coupling of claim 7, further including a clearance area between said collar and said injector socket.

9. The coupling of claim 1, wherein said coupling member includes a seat configured to mate with said collar for capturing said fuel injector.

10. A hanging injector fuel system for an internal combustion engine, comprising:
a fuel rail assembly including an injector socket in fluid communication with a fuel distribution conduit;
a fuel injector assembly including a housing and a coupling member, wherein said coupling member captures said housing and connects said fuel injector assembly to said injector socket; and
a biasing member that enables said fuel injector assembly to pivot relative to said injector socket and urges said fuel injector into contact with said coupling member;
wherein said injector socket includes a first helical thread, wherein said coupling member includes and a second helical thread, and wherein said first helical thread mates with said second helical thread.

11. The hanging injector fuel system of claim 10, wherein said housing includes a radially extending collar, wherein said coupling member includes a seat, and wherein said collar and said seat have mating surfaces.

12. The hanging injector fuel system of claim 11, wherein said biasing member includes a preload that keeps said collar in contact with said seat.

13. The hanging injector fuel system of claim 10, wherein said biasing member is a spring clip.

14. The hanging injector fuel system of claim 13, wherein said spring clip and said fuel injector assembly include mating coincident keyed features that provide rotational orientation of said fuel injector assembly relative to said fuel rail assembly.

15. The hanging injector fuel system of claim 10, wherein said biasing member is a compression spring and wherein said compression spring is positioned between a collar radially extending said housing and said injector socket.

16. The hanging injector fuel system of claim 10, wherein a clearance area is formed between said injector socket and a collar radially extending said housing.
